(19) United States
(12) Patent Application Publication
(10) Pub. No.: US 2016/0378186 A1
(43) Pub. Date: Dec. 29, 2016

(54) TECHNOLOGIES FOR CONTROLLING HAPTIC FEEDBACK INTENSITY

(71) Applicant: Intel Corporation, Santa Clara, CA (US)

(72) Inventor: Kahyun Kim, Hillsboro, OR (US)

(73) Assignee: Intel Corporation, Santa Clara, CA (US)

(21) Appl. No.: 14/747,376

(22) Filed: Jun. 23, 2015

(51) Int. Cl. G06F 3/01

(52) U.S. Cl. CPC G06F 3/016

(57) ABSTRACT

Technologies for adjusting haptic feedback intensity are described. In some embodiments the technologies leverage contextual information detected or otherwise provided by a sensor of an electronic device to determine an adjusted haptic feedback intensity. A control message may be issued to one or more haptic devices, and may be configured to cause the haptic device(s) to produce haptic feedback in accordance with the adjusted haptic feedback intensity. Devices, methods, and computer readable media utilizing such technologies are also described.

### FIELD

The present disclosure relates to technologies for controlling the intensity of haptic feedback provided by an electronic device. More particularly, the present disclosure relates to technologies for controlling the intensity of haptic feedback provided by a mobile device based at least in part on contextual information detected or otherwise provided by a sensor of the mobile device.

### BACKGROUND

Haptic devices (sometimes called “haptic actuators” or “force feedback devices”) are often used in electronic devices to provide haptic feedback or other information to a user. In the video game industry for example, haptic devices are often included in game controllers and are leveraged to provide physical (haptic) feedback to a user that corresponds to events occurring within a game. Haptic devices are also commonly used in the mobile communication device industry, where they are employed to serve as a means of silently notifying a user of the device of the occurrence of an event such as the receipt of a text message, receipt of an e-mail message, an incoming phone call, or the like.

More recently, interest has grown in the use of haptic devices in wearable electronic devices (e.g., smart watches, smart pins, etc.). Similar to their use in mobile communication devices (e.g., cell phones, smart phones and the like), haptic devices are often used in wearable electronic devices to alert users to the occurrence of an event. Unlike a smart phone or cell phone, however, wearable devices often lack a display or have a limited visual channel. User detection of haptic feedback (e.g., detection of a vibration produced by the haptic device) may therefore be more important in the context of wearable devices, as it may be a primary means of alerting a user to the occurrence of an event.

With the foregoing in mind, existing haptics implementations often set the intensity (e.g., the strength of a vibration) of haptic feedback produced by a haptic device to a default level that may or may not be easily changed. In instances where the intensity of haptic feedback may be changed, such change may require a user to manually adjust haptic feedback intensity provided by their device in software, e.g., with a slider that may be interacted with via the user interface of the device. Once set in this manner, the intensity of the haptic feedback may remain fixed until the user changes it again, e.g., by interacting with the slider. In either case such implementations do not account for contextual factors that may impact user detection of haptic feedback at a set haptic feedback intensity.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 depicts one example of a device for controlling haptic feedback intensity, consistent with the present disclosure.

FIG. 2 is a flow diagram of example operations in accordance with one example of a method of controlling the intensity of a haptics signal, consistent with the present disclosure.

Although the following detailed description will proceed with reference being made to illustrative embodiments, many alternatives, modifications, and variations thereof will be apparent to those skilled in the art.

### DETAILED DESCRIPTION

While the present disclosure is described herein with reference to illustrative embodiments for particular applications, it should be understood that such embodiments are for the sake of example only and that the invention as defined by the appended claims is not limited thereto. Those skilled in the relevant art(s) with access to the teachings provided herein will recognize additional modifications, applications, and embodiments within the scope of this disclosure, and additional fields in which embodiments of the present disclosure would be of utility.

As briefly described in the background, mobile and other electronic devices often include one or more haptic devices. Such haptic devices are often employed to alert a user of the electronic device to the occurrence of an event (typically, a reminder, receipt of a message, and/or receipt of a phone call). More specifically, haptic devices may alert a user to the occurrence of an event by providing haptic feedback in the form of a vibration or other tactile stimuli (e.g., movement of a portion of the mobile device) that may be detected by the user. As noted however, existing haptics implementations often set the intensity of the haptic feedback (hereinafter, haptic feedback intensity) to a default level that may or may not be easily changed. In implementations that permit adjustment of the haptic feedback intensity, such adjustment often requires a user to manually adjust the haptic feedback intensity to an adjusted intensity level, e.g., via a slider or other software element that may be interacted with via the user interface of the device. Once the adjustment is made, subsequent haptic feedback will be produced at the adjusted intensity level until the user manually adjusts the intensity again.

The inventor has observed that user detection of haptic feedback may be impacted by various contextual factors at the time such feedback is provided. For example, contextual factors such as but not limited to user activity level, ambient temperature, movement of the electronic device in which the haptic device is included, orientation of the electronic device in which the haptic device is included, combinations thereof, and the like may all have a positive or negative impact on the ability of a user to detect haptic feedback provided at a set intensity. More specifically, when haptic feedback was provided at a fixed intensity, user detection of the feedback was observed to decrease as user activity level increased. Conversely at the same fixed intensity, user detection rate of the haptic feedback was observed to increase as user activity level decreased. Similar observations were made with regard to device orientation, i.e., user detection rate was observed to decrease when a mobile or other electronic device containing a haptic device was in a certain orientation, and to increase when the mobile or other electronic device was in another orientation.

With the foregoing in mind, the present disclosure generally relates to technologies (e.g., devices, methods, computer readable media, and the like) for controlling the intensity of haptic feedback produced by a haptic device. As will be described in detail below, such technologies leverage one or more sensors to detect contextual information that may have an impact on accurate user detection of haptic feedback. More specifically, the technologies described herein may utilize the contextual information to calculate or otherwise determine an adjusted haptic feedback intensity. Subsequently, a control signal may be output to a haptic device (e.g., in response to detection of a triggering event), wherein the control signal is configured to cause the haptic device to produce haptic feedback at the adjusted haptic feedback intensity.

As will be appreciated, the technologies described herein can enable haptic feedback intensity to be autonomously adjusted in view of changes to contextual information detected by one or more sensors of a mobile device. For example as user activity level increases, the technologies described herein may autonomously adjust haptic feedback intensity to a relatively high level, so as to enhance user detection of the haptic feedback. In contrast as user activity level decreases, the technologies may autonomously adjust haptic feedback intensity to a relatively low level, e.g., so as to conserve battery life while retaining adequate user detection of the haptic feedback.

It is noted that in the context of the present disclosure, the term “haptic feedback intensity” is used herein to refer to the strength of haptic feedback that may be provided by a haptic device. For example where haptic feedback is provided in the form of a vibration, haptic feedback intensity refers to the relative intensity of the vibration.

The term “adjusted haptic feedback intensity” also refers to the strength of haptic feedback that may be provided by a haptic device, but is in relation to a previous or default haptic feedback intensity that may have been previously employed. More specifically, adjusted haptic feedback intensity refers to a strength of haptic feedback determined by the technologies described herein based at least in part on contextual information provided by one or more sensors. While an adjusted haptic feedback intensity is often different from a previous or default haptic feedback intensity, the term is also used herein to refer to a haptic feedback intensity that is determined based at least in part on contextual information provided by one or more sensors, but which is the same as a previous or default haptic feedback intensity.

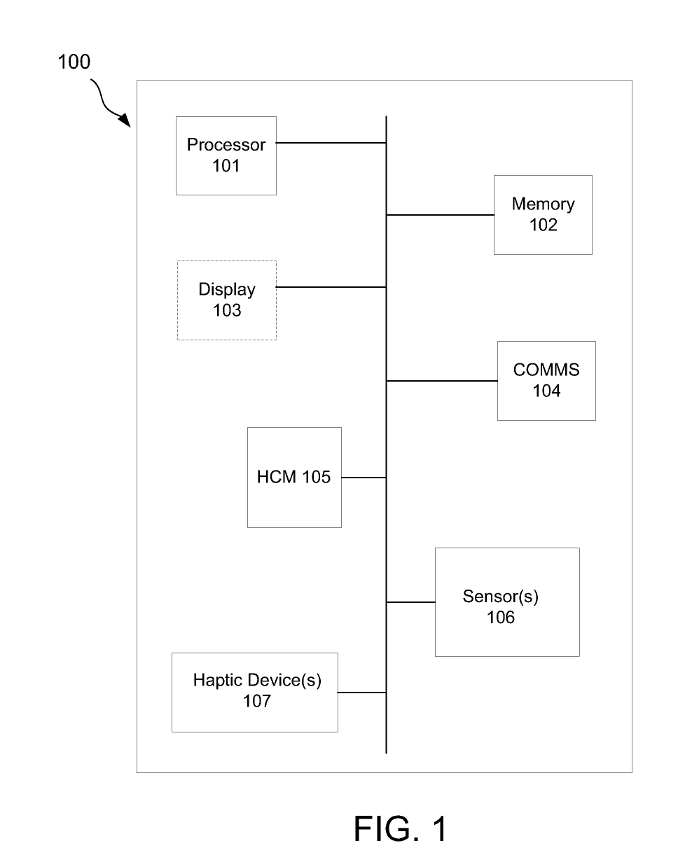

Reference is now made to FIG. 1, which is a block diagram of system level architecture of one example of an electronic device for controlling haptic feedback intensity consistent with the present disclosure. In general, device 100 may be in the form of any suitable mobile or other electronic device. Non-limiting examples of such devices include but are not limited to cameras, cell phones, computer terminals, desktop computers, electronic readers, facsimile machines, kiosks, netbook computers, notebook computers, internet devices, payment terminals, personal digital assistants, media players and/or recorders, one or more servers, set-top boxes, smart phones, tablet personal computers, ultra-mobile personal computers, wearable electronic devices (e.g., wrist worn electronic devices such as a smart watch, belt worn smart devices such as smart belt buckles, shirt worn smart devices such as smart pins, electronic head ware such as smart eyewear, combinations thereof, and the like), wired telephones, combinations thereof, and the like. Such devices may be portable or stationary. Without limitation, in some embodiments the devices described herein are in the form of a mobile electronic device such as a smart phone, a cell phone, a tablet personal computer, an ultra-mobile personal computer, a wearable electronic device, or the like. In still further non-limiting embodiments, the devices described herein may be in the form of wrist worn wearable electronic device, such as but not limited to a smart watch.

Regardless of its form factor and as shown in FIG. 1, device 100 includes processor 101, memory 102, optional display 103, communications (COMMS) interface 104, haptic control module (HCM) 105, sensor(s) 106, and haptic device(s) 107. All of such components may be communicatively coupled to one another via a suitable interface, such as a bus. It is noted that for the sake of clarity FIG. 1 depicts system 100 with limited components, with various components that may be typically found in various electronic devices (e.g., antennas, multiplexers, etc. as may be found in modern mobile communications devices) omitted. One of ordinary skill will understand that the omitted components may be included in the device architecture of device 100 on an as needed or as desired basis. It should be further understood that any or all of the components of FIG. 1 may form all or a part of a device platform corresponding to the type of electronic device in question. Thus for example where device 100 is a smart phone, all or a portion of the components of FIG. 1 may be present on a smart phone platform. In contrast where device 100 is a smart watch, all or a portion of the components of FIG. 1 may be present on a smart watch platform.

It is noted that for the sake of clarity and ease of understanding, the various components of device 100 are illustrated in FIG. 1 and are described herein as though they are part of a single electronic device, such as single mobile device or a single wearable device. It should be understood that this description and illustration are for the sake of example only, and that the various components of device 100 need not be incorporated into a single device. For example, the present disclosure envisions embodiments in which sensors 106 may be separate from device 100. Without limitation, in some embodiments device 100 is in the form of a mobile electronic device (e.g., a smart phone or a wearable device) that includes an appropriate device platform (not shown) that contains all of the components of FIG. 1.

Processor 101 may be any suitable general purpose processor or application specific integrated circuit, and may be capable of executing one or multiple threads on one or multiple processor cores. Without limitation in some embodiments processor 101 is a general purpose processor, such as but not limited to the general purpose processors commercially available from INTEL® Corp., ADVANCED MICRO DEVICES®, ARM®, NVIDIA®, APPLE®, and SAMSUNG®. In other embodiments, processor 101 may be in the form of a very long instruction word (VLIW) and/or a single instruction multiple data (SIMD) processor (e.g., one or more image video processors, etc.). It should be understood that while FIG. 1 illustrates device 100 as including a single processor 101, multiple processors may be used.

Memory 102 may be any suitable type of computer readable memory. Example memory types that may be used as memory 102 include but are not limited to: semiconductor firmware memory, programmable memory, non-volatile memory, read only memory, electrically programmable memory, random access memory, flash memory (which may include, for example NAND or NOR type memory structures), magnetic disk memory, optical disk memory, combinations thereof, and the like. Additionally or alternatively, memory 102 may include other and/or later-developed types of computer-readable memory. Without limitation, in some embodiments memory 102 is configured to store data such as computer readable instructions in a non-volatile manner.

When used, optional display 103 may be any suitable device for displaying data, content, information, a user interface, etc., e.g. for consumption and/or use by a user of device 100. Thus for example, optional display 103 may be in the form of a liquid crystal display, a light emitting diode (LED) display, an organic light emitting diode (OLED) display, a touch screen, combinations thereof, and the like.

COMMS 104 may include hardware (i.e., circuitry), software, or a combination of hardware and software that is configured to allow device 100 to receive and/or transmit data or other communications. For example, COMMs 104 may be configured to enable device 100 to receive one or more contextual information signals from sensors 106, e.g., over a wired or wireless communications link (not shown). Alternatively or additionally, COMMS 104 may enable device 100 to send and receive data and other signals to and from another electronic device, such as another mobile or stationary computer system (e.g., a third party computer and/or server, a third party smart phone, a third party laptop computer, etc., combinations thereof, and the like). COMMS 104 may therefore include hardware to support wired and/or wireless communication, e.g., one or more transponders, antennas, BLUETOOTH™ chips, personal area network chips, near field communication chips, wired and/or wireless network interface circuitry, combinations thereof, and the like.

As will be described in further detail below, device 100 may be configured to monitor at least one contextual information signal (e.g., from sensor(s) 106) and determine an adjusted haptic feedback intensity based at least in part that contextual information. In addition, device 100 may be configured to output control signals to one or more haptic devices (e.g., haptic device(s) 107) in response to a triggering event, so as to cause the haptic device(s) to produce haptic feedback at the adjusted haptic feedback intensity.

In this regard, in some embodiments device 100 includes haptic control module (HCM) 105. In some embodiments HCM 105 may be in the form of hardware or logic implemented at least in part in hardware to perform haptic feedback control operations consistent with the present disclosure. Alternatively or additionally, HCM 105 may include or be in the form of a computer readable storage medium (in which case, e.g., HCM 105 may be maintained in memory 102) including instructions which when executed by a processor (e.g., processor 101) of device 100, cause device 100 to perform haptic feedback control operations consistent with the present disclosure.

Sensor(s) 106 may be any suitable sensor for detecting and/or taking measurements of contextual information which may be correlated to the ability of a user of device 101 to detect haptic feedback. Non-limiting examples of such contextual information includes information regarding the motion of device 100 such as accelerometer data, global positioning system data, combinations thereof, and the like. Further non-limiting examples of contextual information includes device orientation information, such as gyroscope data. Still further non-limiting examples of contextual information includes user activity information, for example biometric information such as a user's heart rate, blood pressure, blood oxygen level, presence or absence of sweat, body temperature, etc., muscle actuation information such as electromyography data, brain activity information such as electroencephalography data, combinations thereof, and the like. Sensor(s) 106 may therefore be in the form of a device motion sensor such as an accelerometer, a global positioning system, a gyroscope, etc., a biosensor such as a heart rate sensor, a blood pressure sensor, a blood oxygen level sensor (e.g., a pulse oximetry sensor), a body temperature sensor, a sweat sensor, a electromyography sensor, an electroencephalography sensor, etc., combinations thereof, and the like. Without limitation, in some embodiments sensor(s) 106 include at least an accelerometer and a gyroscope.

It is noted that while sensor(s) 106 is/are shown in FIG. 1 as integrated with device 100, such a configuration is not required. Indeed, the present disclosure envisions embodiments in which sensor(s) 106 is/are not integrated with device 100, except insofar as it/they may be in wired or wireless communication with device 100. For example in some embodiments, device 100 may in the form of a wearable device (e.g., a wrist worn wearable) that is in wired or wireless communication with a smart phone or other mobile device, wherein one or more of sensor(s) 106 are disposed in the smart phone or other mobile device.

Sensor(s) 106 may be configured to detect or otherwise obtain contextual information and transmit one or more contextual information signals to HCM 105. In general, the contextual information signals may be configured to cause HCM 105 to determine an adjusted haptic feedback intensity based at least in part on the contextual information detected or otherwise reported by sensor(s) 106. In some embodiments, the contextual information signals may contain raw (e.g., unprocessed) contextual information detected or otherwise reported by sensor(s) 106. Alternatively or additionally, sensor(s) 106 may be configured to process raw sensor data into a scalar or other indicator that correlates to the ability of a user of device 100's to detect haptic feedback, e.g., provided by haptic device(s) 107. In such instances the contextual information signal(s) produced by sensors may include such a scalar/indicator, either alone or in combination with raw contextual information.

In some embodiments the contextual information detected by sensor(s) 106 may correspond to and/or otherwise be associated with movement and/or stimulation of all or a portion of a user's body. For example where device 100 is a wrist worn wearable device (e.g., a smart watch) and sensor(s) 106 include an accelerometer, data produced by the accelerometer may correlate to movement (e.g., swinging) user's lower arm, wrist, and/or hand. Similarly where sensor(s) 106 include a gyroscope, data produced by the gyroscope may correlate to an orientation of device 100 and, hence, an orientation of the lower arm, wrist, and/or hand of a user. In instances where device 100 is a mobile device such as a smart phone, data produced by sensor(s) 106 may correlate to motion and/or orientation of the mobile device.

Alternatively or additionally, data produced by sensor(s) 106 may include biometric data of a user of device 100. Such biometric information may include for example, user heart rate, user blood pressure, user blood oxygen level, presence or absence of skin moisture (e.g., sweat), combinations thereof, and the like. Alternatively or additionally, where sensor(s) 106 includes an electromyography or electroencephalography sensor, data produced by sensor(s) 106 may include electromyography data or electroencephalography data, wherein such data represents the stimulation of muscles and/or the brain of a user of device 100. In such instances, contextual information included in a contextual information signal may include such biometric information, either alone or in combination with accelerometer and/or gyroscope data.

As noted above contextual information signals may be transmitted from sensor(s) 106 to HCM 105. In general, HCM 105 may be configured to analyze the content of the contextual information signals (e.g., the raw contextual information and/or scalar/indicator values therein), and to calculate or otherwise determine an adjusted haptic feedback intensity. In this regard, in some embodiments HCM 105 may compare the contextual information and/or scalars/indicators in a contextual information signal to one or more thresholds, and calculate or otherwise determine an adjusted haptic feedback intensity based on such comparison.

For example where sensor(s) 106 include an accelerometer, contextual information signals produced by sensor(s) 106 may include raw accelerometer data and/or corresponding scalar/indicator values therein. In response to receipt of a contextual information signal containing such data, HCM 105 may compare that data to one or more accelerometer thresholds, wherein each threshold associates an accelerometer value with an adjusted haptic feedback intensity. For example, HCM 105 may employ a series of 2, 5, 10 20, or even 100 accelerometer thresholds, wherein each threshold is associated with a different adjusted haptic feedback intensity level.

In some embodiments, lower value thresholds (e.g., signifying slower or less movement) may be associated with adjusted haptic feedback levels that are relatively weak, e.g., compared to a previous or default haptic feedback intensity. Likewise high value thresholds (e.g., signifying faster or great movement) may be associated with adjusted haptic feedback levels that are relatively strong, e.g., compared to a previous or default haptic feedback intensity.

In other embodiments sensor(s) 106 may include a gyroscope, in which case contextual information signals produced by sensor(s) 106 may include raw gyroscope data and/or corresponding scalar/indicator values therein. In response to receipt of a contextual information signal containing such data, HCM 105 may analyze the gyroscope data to determine an orientation of device 100. Device 100 may then compare the determined device orientation to a database (e.g., maintained in memory 102 or another location) correlating each of a plurality of device orientations to a corresponding adjusted haptic feedback intensity. That is, the database may correlate a first device orientation with a first adjusted haptic feedback intensity, a second device orientation with a second adjusted haptic feedback intensity, a third device orientation with a third feedback intensity, etc. Alternatively or additionally, the database may correlate various device orientations with a multiplier or other scaling factor, which may be used to fine tune other adjustments to haptic feedback intensity to account for device orientation, as discussed later.

In still further embodiments sensor(s) 106 may include a biosensor such as those noted above. In such instances contextual information signals produced by sensor(s) 106 may include raw biosensor data (or corresponding scalar/indicator values therein). In response to receipt of a contextual information signal containing such data, HCM 105 may analyze the biosensor data to determine to determine whether an adjustment to haptic feedback intensity needs to be made. For example, HCM 105 may compare the detected heart rate of a user to one or heart rate thresholds, and make an appropriate adjustment to haptic feedback intensity. In some embodiments, when a user's heart rate exceeds a first (e.g., high) threshold level, HCM 105 may determine that an increase in haptic feedback intensity is needed to maintain an acceptable user detection rate. Conversely where a user's heart rate is below a second (e.g., low) threshold, HCM 105 may determine that no adjustment to haptic feedback intensity is need or, alternatively, that haptic feedback intensity may be decreased, e.g., to conserve battery power. Where the user's heart rate is between the first and second thresholds, HCM 105 may determine that no adjustment to haptic feedback intensity is needed. Of course more than two thresholds may be employed, e.g., in a similar manner as described above with respect to accelerometer data. Similar analyses may also be performed with regard to other types of biometric contextual information noted above. In any case the degree to which the haptic feedback intensity is adjusted (i.e., the value of the adjusted haptic feedback intensity) may be a function of the contextual information. That is, the degree to which haptic feedback intensity is adjusted may depend on the degree to which contextual information suggests to HCM 105 that a user will be more or less sensitive to haptic feedback, i.e., will be more or less likely to detect haptic feedback provided by haptic device(s) 107.

It is noted that for the sake of clarity the above discussion focuses on instances in which HCM 105 calculates or otherwise determines an adjusted haptic intensity based on a single type of contextual information. It should be understood that such discussion is for the sake of example, and that the operations of HCM 105 are not limited to such implementations. Indeed the present disclosure envisions embodiments wherein HCM 105 leverages a combination of different types of contextual information to determine an appropriate adjusted haptic feedback intensity. For example, in some embodiments sensor(s) 106 may include an accelerometer and a gyroscope. In such embodiments HCM 105 may, in response to receipt of a contextual information signal containing accelerometer data and gyroscope data, calculate or otherwise determine an adjusted haptic feedback intensity based at least in part on both accelerometer data and gyroscope data.

For example, in some embodiments HCM 105 may initially utilize the accelerometer data to determine whether an adjustment to haptic feedback intensity is warranted (e.g., using thresholding as discussed above). If HCM 105 determines that an adjustment is warranted, it may set an initial adjusted haptic feedback intensity based on the accelerometer data alone (as discussed above). HCM 105 may then analyze the gyroscope data as discussed above, and determine whether further adjustment of the haptic feedback intensity is desired. For example, HCM 105 may determine from the gyroscope data that device 100 is in an orientation that negatively or positively the ability of a user to detect haptic feedback. In such instances HCM 105 may apply a multiplier or other factor correlating to that orientation to the adjusted haptic feedback intensity (as set based on the accelerometer data alone). In this way, the gyroscope data may be used to further strengthen or weaken the haptic feedback intensity, so as to account for device orientation.

While the foregoing example focuses on the use of accelerometer data to initially determine an adjustment to haptic feedback intensity, such a configuration is not required. Indeed the present disclosure envisions embodiments in which gyroscope data may be used to initially determine whether an adjustment to haptic feedback intensity is warranted, after which accelerometer data may be used to strengthen or weaken the adjusted feedback intensity to account for motion of device 101. The other contextual information types noted above (e.g., heart rate, sweat detection, etc.) may also be used to determine whether an initial adjustment to haptic feedback intensity is warranted or to tune an adjusted haptic feedback intensity to account for their respective indications. As the implementation of such data types in such determinations is the same or highly similar to the above discussion pertaining to gyroscope and accelerometer data, an explanation of how such data types may be used is not reiterated for the sake of brevity.

It is also noted that while the foregoing discussion focuses on embodiments in which HCM 105 may sequentially analyze contextual data to determine an adjusted feedback intensity, such implementations are not required. Indeed the present disclosure envisions embodiments in which HCM 105 simultaneously takes various contextual data types into account when determining an adjusted haptic feedback intensity. For example, in some embodiments HCM 105 may implement an algorithm that defines an adjusted haptic feedback intensity as a function of two or more of the above noted contextual information types, such as a combination of accelerometer data and gyroscope data, either alone or in combination with biometric data.

Regardless of how an adjusted haptic feedback intensity is determined, once such a determination is made in some embodiments HCM 105 may monitor for the occurrence of an event that triggers the issuance of haptic feedback, e.g., by haptic device(s) 107. For the sake of clarity, such events are referred to herein as a “triggering event.” Non-limiting examples of triggering events include the receipt of a text or other electronic message, receipt of a telephone call, an electronic calendar event (e.g., reminder), expiration of a time period, detection of a threshold biometric condition (heart rate, blood pressure, blood oxygen level, etc.), an alarm, an alert signifying arrival at a certain location, combinations thereof, and the like. In response to detection of such an event, HCM 105 may transmit a control message to haptic device(s) 107 via a wired or wireless communication channel. The control message may be configured to cause haptic device(s) 107 to produce haptic feedback in accordance with the adjusted haptic feedback intensity.

Of course HCM 105 need not always be configured to transmit a control message to haptic devices 107 in response to detection of a triggering event. Indeed in some embodiments, HCM 105 may transmit a control signal to haptic device(s) 107 irrespective of the detection of a triggering event. Like the prior embodiments, the control message may be configured to cause haptic device(s) 107 to produce haptic feedback in accordance with the adjusted feedback intensity. In these instances, however, production of haptic feedback by haptic device(s) 107 may be controlled by haptic device(s) 107 or another component of device 101 (e.g., a haptic device controller). In such instances, haptic device(s) 107 or another component of device 101 (e.g., a haptic device controller) may monitor for the occurrence of a triggering event and, in response to detection of such an event, cause haptic device(s) 107 to produce haptic feedback at the adjusted haptic feedback intensity specified in the control message.

Any suitable type of haptic device (or combination thereof) may be employed as haptic device(s) 107. Such haptic devices may include one or more actuators or other elements which are configured to provide haptic and/or tactile feedback to a user of device 101. Non-limiting examples of suitable haptic devices and/or actuators that may be employed include electrostatic haptic devices, piezoelectric haptic devices, motor-based haptic devices (e.g., eccentric mass motors, shaftless vibration motors, etc.), linear actuators, pneumatic actuators, surface acoustic wave actuators, electrostimulation devices, pressure valve devices, combinations thereof, and the like. Of course, other past, present, and future types of haptic devices may be employed and are envisioned by the present disclosure.

It should be understood that haptics are closely related to tactile technologies. Therefore unless otherwise expressly indicated herein, the terms “haptic” and “haptics” should be understood to include both haptic devices and technologies as well as tactile devices and technologies.

Regardless of its type, haptic device(s) 107 may be configured to provide haptic feedback at various intensity levels. For example haptic device(s) 107 may be initially configured to provide haptic feedback at a default intensity level, wherein the default intensity level may be controlled to an adjusted haptic feedback intensity, e.g., in response to a control message from HCM 105 as discussed above.

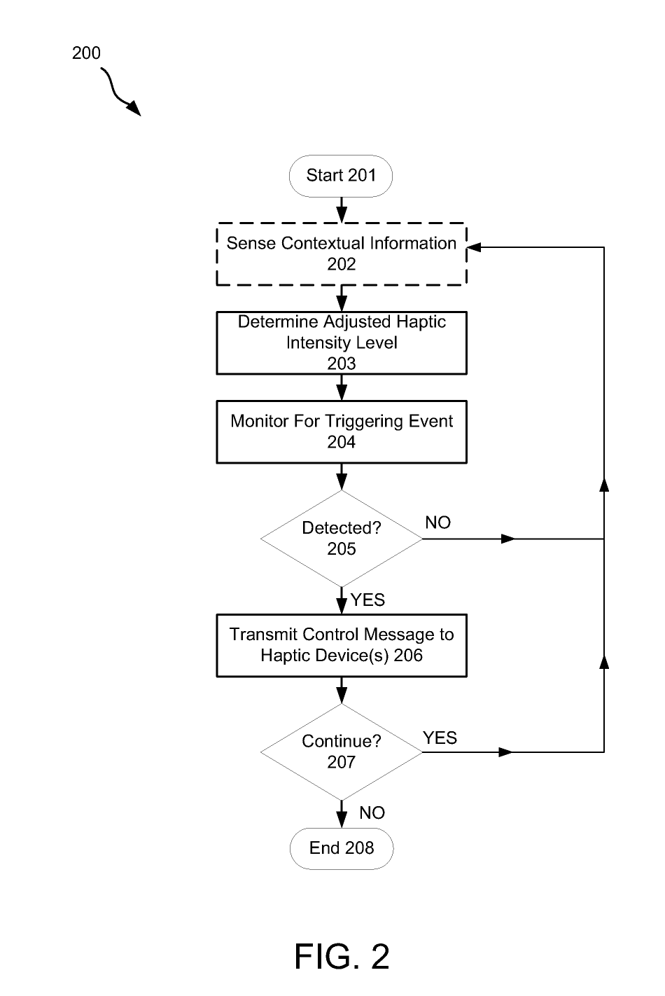

Another aspect of the present disclosure relates to methods of controlling haptic feedback intensity. In this regard reference is made to FIG. 2, which is a flow diagram of example operations that may be performed in accordance with one example of a method of controlling haptic feedback intensity consistent with the present disclosure. As shown, method 200 begins at block 201. The method may then proceed to optional block 202, wherein contextual information may be sensed or otherwise determined, e.g., by one or more sensors of a mobile or other electronic device, as discussed above.

Once contextual information is sensed or otherwise determined (or if the operations of block 202 are not required), the method may proceed to block 303, wherein an adjusted haptic intensity may be determined. The manner in which an adjusted haptic intensity may be determined is discussed in detail above, and for the sake of brevity is not reiterated.

Once an adjusted haptic intensity level is determined, the method may proceed to block 204, wherein operations may be performed to monitor for the occurrence of a triggering event, i.e., an event provoking the production of haptic feedback by one or more haptic devices. At block 205, a determination may be made as to whether a triggering event has been detected. If not, the method may loop back to optional block 202 or, alternatively, to block 203. If a triggering event is detected, however, the method may proceed from block 205 to block 206, pursuant to which a control message may be generated and transmitted to one or more haptic devices. As discussed above, the control message may be configured to cause the haptic device(s) to produce the haptic feedback at the adjusted haptic intensity determined pursuant to block 203.

In alternative embodiments, once an alternative haptic intensity level is determined pursuant to block 203, the method may proceed directly to block 206, pursuant to which a control message is generated and transmitted to one or more haptic devices. In this instance the control message may be configured to program or otherwise configure the haptic devices such that when a triggering event is detected by such devices (or another component of a mobile or other electronic device), the haptic devices produce haptic feedback in accordance with the adjusted haptic feedback intensity.

In any case once a control message has been transmitted to a haptic control device, the method may proceed to block 207. Pursuant to block 207 a determination may be made as to whether the method is to continue. If so, the method may loop back to block 202 or, alternatively, to block 203. If the method is not to continue, however, it may proceed to block 208 and end.

Another aspect of the present disclosure relates to computer readable media that include instructions that when executed by a processor of an electronic device, cause the electronic device to perform haptic feedback intensity control operations consistent with the present disclosure. More specifically, in some embodiments the instructions when executed by a processor of an electronic device cause the electronic device to perform one or more operations of the method of FIG. 2 described above, and/or any of the operations specified for various components of FIG. 1 described above.

### EXAMPLES

The following examples pertain to further embodiments and comprise subject material such as a system, a device, a method, a computer readable storage medium storing instructions that when executed cause a machine to perform acts based on the method, and/or means for performing acts based on the method, as provided below.

### Example 1

According to this example there is provided an electronic device including a processor, a memory, a contextual information sensor, a haptic control module (HCM), and a haptic device, wherein: the haptic control module includes circuitry to: determine an adjusted haptic feedback intensity based at least in part on contextual information received from the contextual information sensor; and transmit a control message to the haptic device; the control message being configured to cause the haptic device to generate haptic feedback in accordance with the adjusted haptic feedback intensity, in response to a triggering event.

### Example 2

This example includes any or all of the features of example 1, wherein the electronic device is a mobile electronic device.

### Example 3

This example includes any or all of the features of example 2, wherein the mobile electronic device is a wearable device.

### Example 4

This example includes any or all of the features of example 3, wherein the wearable device is a wrist worn wearable device.

### Example 5

This example includes any or all of the features of any one of examples 1 to 5, wherein the sensor is selected from the group consisting of a device motion sensor, a biosensor, or a combination thereof.

### Example 6

This example includes any or all of the features of example 5, wherein the sensor includes a device motion sensor selected from the group consisting of an accelerometer, a global positioning system, a gyroscope, or one or more combinations thereof.

### Example 7

This example includes any or all of the features of example 6, wherein the sensor includes at least an accelerometer and a gyroscope.

### Example 8

This example includes any or all of the features of example 5, wherein the sensor includes a biosensor selected from the group consisting of a body temperature sensor, a blood pressure sensor, a blood oxygen level sensor, a sweat sensor, an electromyography sensor, an electroencephalography sensor, and one or more combinations thereof.

### Example 9

This example includes any or all of the features of any one of examples 1 to 8, wherein the contextual information correlates to an ability of a user of the electronic device to detect the haptic feedback.

### Example 10

This example includes any or all of the features of any one of examples 1 to 9, wherein the circuitry is configured to determine the adjusted haptic feedback intensity at least in part by comparing contextual information in the contextual information signal to one or more thresholds.

### Example 11

This example includes any or all of the features of example 10, wherein the contextual information includes accelerometer data, the one or more thresholds comprise a plurality of accelerometer thresholds, wherein: each accelerometer threshold of the plurality of accelerometer thresholds is associated with a corresponding adjusted haptic feedback intensity; and the circuitry is configured to determine the adjusted haptic feedback intensity at least in part by comparing the accelerometer data to the plurality of accelerometer thresholds.

### Example 12

This example includes any or all of the features of any one of examples 1 to 11, wherein: the contextual information includes gyroscope data; the electronic device further includes a database in the memory, the database correlating a plurality of device orientations to a corresponding adjusted haptic feedback intensity; and the circuitry is configured to determine the adjusted haptic feedback intensity at least in part by determining an orientation of the electronic device based at least in part on the gyroscope data, and comparing the orientation to the database.

### Example 13

This example includes any or all of the features of any one of examples 1 to 12, wherein: the contextual information includes accelerometer data and gyroscope data; and the circuitry is configured to determine the adjusted haptic feedback intensity based at least in part on a combination of the accelerometer data and the gyroscope data.

### Example 14

This example includes any or all of the features of any one of examples 1 to 13, wherein: the contextual information includes accelerometer data and gyroscope data; the circuitry is configured to determine an initial adjusted haptic feedback intensity based on one of the accelerometer data and the gyroscope data; and the circuitry is further configured to tune the initial adjusted haptic feedback intensity based on the other of the accelerometer data and the gyroscope data.

### Example 15

This example includes any or all of the features of any one of examples 1 to 14, wherein the circuitry is further to detect the occurrence of the triggering event, and to transmit the control message in response to detection of the triggering event.

### Example 16

This example includes any or all of the features of any one of examples 1 to 15 wherein: the circuitry is to transmit the control message irrespective of the occurrence of the triggering event; the haptic device is to monitor for the occurrence of the triggering event; and in response to detection of the triggering event, the haptic device is to produce haptic feedback at the adjusted haptic feedback intensity.

### Example 17

This example includes any or all of the features of any one of examples 1 to 16, wherein the adjusted haptic feedback intensity is configured to achieve a desired user detection rate for the haptic feedback.

### Example 18

According to this example there is provided a method of adjusting haptic feedback intensity including, with an electronic device: determining an adjusted haptic feedback intensity based at least in part on contextual information detected or otherwise provided by a contextual information sensor; and transmitting, in response to a triggering event, a control message to a haptic device of the electronic device, the control message configured to cause the haptic device to generate haptic feedback in accordance with the adjusted haptic feedback intensity.

### Example 19

This example includes any or all of the features of example 18, wherein the electronic device is a mobile electronic device.

### Example 20

This example includes any or all of the features of example 19, wherein the mobile electronic device is a wearable device.

### Example 21

This example includes any or all of the features of example 20, wherein the wearable device is a wrist worn wearable device.

### Example 22

This example includes any or all of the features of any one of examples 18 to 21, wherein the sensor is selected from the group consisting of a device motion sensor, a biosensor, or a combination thereof.

### Example 23

This example includes any or all of the features of example 22, wherein the sensor includes a device motion sensor selected from the group consisting of an accelerometer, a global positioning system, a gyroscope, or one or more combinations thereof.

### Example 24

This example includes any or all of the features of example 23, wherein the sensor includes at least an accelerometer and a gyroscope.

### Example 25

This example includes any or all of the features of example 23, wherein the sensor includes a biosensor selected from the group consisting of a body temperature sensor, a blood pressure sensor, a blood oxygen level sensor, a sweat sensor, and one or more combinations thereof.

### Example 26

This example includes any or all of the features of any one of examples 18 to 26, wherein the contextual information correlates to an ability of a user of the electronic device to detect the haptic feedback.

### Example 27

This example includes any or all of the features of any one of examples 18 to 27, wherein determining the adjusted haptic feedback intensity is performed at least in part by comparing contextual information in the contextual information signal to one or more thresholds.

### Example 28

This example includes any or all of the features of example 27, wherein: the contextual information includes accelerometer data, the one or more thresholds comprise a plurality of accelerometer thresholds, each of which is associated with a corresponding adjusted haptic feedback intensity; and determining the adjusted haptic feedback intensity includes comparing the accelerometer data to the plurality of thresholds.

### Example 29

This example includes any or all of the features of any one of examples 18 to 28, wherein: the contextual information includes gyroscope data; the electronic device further includes a database correlating a plurality of device orientations to a corresponding adjusted haptic feedback intensity; and determining the adjusted haptic feedback intensity includes determining an orientation of the electronic device based at least in part on the gyroscope data, and comparing the orientation to the database.

### Example 30

This example includes any or all of the features of any one of examples 18 to 29, wherein: the contextual information includes accelerometer data and gyroscope data; and determining the adjusted haptic feedback intensity is based at least in part on a combination of the accelerometer data and the gyroscope data.

### Example 31

This example includes any or all of the features of any one of examples 18 to 29, wherein: the contextual information includes accelerometer data and gyroscope data; determining the adjusted haptic feedback intensity includes: determining an initial adjusted haptic feedback intensity based on one of the accelerometer data and the gyroscope data; and tuning the initial adjusted haptic feedback intensity based on the other of the accelerometer data and the gyroscope data.

### Example 32

This example includes any or all of the features of any one of examples 18 to 31, further including: detecting the occurrence of the triggering event.

### Example 33

This example includes any or all of the features of any one of examples 18 to 33, and further includes: transmitting the control message irrespective of the occurrence of the triggering event; and in response to detection of the triggering event, producing the haptic feedback at the adjusted haptic feedback intensity.

### Example 34

According to this example there is provided at least one computer readable medium including instructions which when executed by a processor of an electronic device cause the electronic device to perform the following operations including: determining an adjusted haptic feedback intensity based at least in part on contextual information detected or otherwise provided by a contextual information sensor; and transmitting a control message to a haptic device of the electronic device, the control message configured to cause the haptic device to generate haptic feedback in accordance with the adjusted haptic feedback intensity, in response to a triggering event.

### Example 35

This example includes any or all of the features of example 34, wherein the electronic device is a mobile electronic device.

### Example 36

This example includes any or all of the features of example 35, wherein the mobile electronic device is a wearable device.

### Example 37

This example includes any or all of the features of example 36, wherein the wearable device is a wrist worn wearable device.

### Example 38

This example includes any or all of the features of any one of examples 34 to 37, wherein the sensor is selected from the group consisting of a device motion sensor, a biosensor, or a combination thereof.

### Example 39

This example includes any or all of the features of example 38, wherein the sensor includes a device motion sensor selected from the group consisting of an accelerometer, a global positioning system, a gyroscope, or one or more combinations thereof.

### Example 40

This example includes any or all of the features of example 39, wherein the sensor includes at least an accelerometer and a gyroscope.

### Example 41

This example includes any or all of the features of any one of example 38, wherein the sensor includes a biosensor selected from the group consisting of a body temperature sensor, a blood pressure sensor, a blood oxygen level sensor, a sweat sensor, and one or more combinations thereof.

### Example 42

This example includes any or all of the features of any one of examples 34 to 41, wherein the contextual information correlates to an ability of a user of the electronic device to detect the haptic feedback.

### Example 43

This example includes any or all of the features of any one of examples 34 to 42, wherein determining the adjusted haptic feedback intensity is performed at least in part by comparing contextual information in the contextual information signal to one or more thresholds.

### Example 44

This example includes any or all of the features of any one of examples 34 to 43, wherein: the contextual information includes accelerometer data, the one or more thresholds comprise a plurality of accelerometer thresholds, each of which is associated with a corresponding adjusted haptic feedback intensity; and determining the adjusted haptic feedback intensity includes comparing the accelerometer data to the plurality of thresholds.

### Example 45

This example includes any or all of the features of any one of examples 34 to 44, wherein: the contextual information includes gyroscope data; the electronic device further includes a database correlating a plurality of device orientations to a corresponding adjusted haptic feedback intensity; and determining the adjusted haptic feedback intensity includes determining an orientation of the electronic device based at least in part on the gyroscope data, and comparing the orientation to the database.

### Example 46

This example includes any or all of the features of any one of examples 34 to 45, wherein: the contextual information includes accelerometer data and gyroscope data; and determining the adjusted haptic feedback intensity is based at least in part on a combination of the accelerometer data and the gyroscope data.

### Example 47

This example includes any or all of the features of any one of examples 34 to 46, wherein: the contextual information includes accelerometer data and gyroscope data; determining the adjusted haptic feedback intensity includes: determining an initial adjusted haptic feedback intensity based on one of the accelerometer data and the gyroscope data; and tuning the initial adjusted haptic feedback intensity based on the other of the accelerometer data and the gyroscope data.

### Example 48

This example includes any or all of the features of any one of examples 34 47, wherein the instructions when executed further cause the electronic device to perform the following operations including: detecting the occurrence of the triggering event; and transmitting the control message in response to detection of the triggering event.

### Example 49

This example includes any or all of the features of any one of examples 34 to 48, wherein the instructions when executed further cause the electronic device to perform the following operations including: transmitting the control message irrespective of the occurrence of the triggering event; and in response to detection of the triggering event, producing the haptic feedback at the adjusted haptic feedback intensity.

### Example 50

According to this example there is provided at least one computer readable medium including instructions which when executed by a process of an electronic device cause the electronic device to perform the method of any one of examples 18 to 33.

### Example 51

According to this example there is provided an apparatus including means to perform the method of any one of examples 18 to 33.

### Example 52

According to this example there is provided an electronic device including: processing means, memory means, contextual information sensing means to sense contextual information of a user of the electronic device; haptic control means, and haptic feedback means, wherein: the haptic control means is to determine an adjusted haptic feedback intensity based at least in part on contextual information received from the contextual information means; and the haptic control means is further to cause the haptic feedback means to generate haptic feedback in accordance with the adjusted haptic feedback intensity, in response to a triggering event.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

What is claimed is:

1. An electronic device comprising a processor, a memory, a contextual information sensor, a haptic control module (HCM), and a haptic device, wherein:
the haptic control module comprises circuitry to:
determine an adjusted haptic feedback intensity based at least in part on contextual information received from the contextual information sensor; and
transmit a control message to the haptic device;
the control message being configured to cause said haptic device to generate haptic feedback in accordance with the adjusted haptic feedback intensity, in response to a triggering event.

2. The electronic device of claim 1, wherein said sensor is selected from the group consisting of a device motion sensor, a biosensor, or a combination thereof.

3. The electronic device of claim 2, wherein said sensor comprises a device motion sensor selected from the group consisting of an accelerometer, a global positioning system, a gyroscope, or one or more combinations thereof.

4. The electronic device of claim 1, wherein said circuitry is configured to determine said adjusted haptic feedback intensity at least in part by comparing contextual information in said contextual information signal to one or more thresholds.

5. The electronic device of claim 4, wherein said contextual information comprises accelerometer data, said one or more thresholds comprise a plurality of accelerometer thresholds, wherein:
each accelerometer threshold of said plurality of accelerometer thresholds is associated with a corresponding adjusted haptic feedback intensity; and
said HCM is configured to determine said adjusted haptic feedback intensity at least in part by comparing said accelerometer data to said plurality of accelerometer thresholds.

6. The electronic device of claim 4, wherein:
said contextual information comprises gyroscope data;
said electronic device further comprises a database in said memory, said database correlating a plurality of device orientations to a corresponding adjusted haptic feedback intensity; and
said circuitry is configured to determine said adjusted haptic feedback intensity at least in part by determining an orientation of said electronic device based at least in part on said gyroscope data, and comparing said orientation to said database.

7. The electronic device of claim 4, wherein:
said contextual information comprises accelerometer data and gyroscope data; and
said circuitry is configured to determine said adjusted haptic feedback intensity based at least in part on a combination of said accelerometer data and said gyroscope data.

8. The electronic device of claim 4, wherein:
said contextual information comprises accelerometer data and gyroscope data;
said circuitry configured to determine an initial adjusted haptic feedback intensity based on one of said accelerometer data and said gyroscope data; and
said circuitry is further configured to tune said initial adjusted haptic feedback intensity based on the other of said accelerometer data and said gyroscope data.

9. The electronic device of claim 1, wherein said electronic device is a wearable electronic device.

10. A method of adjusting haptic feedback intensity comprising, with an electronic device:
determining an adjusted haptic feedback intensity based at least in part on contextual information detected or otherwise provided by a contextual information sensor; and
transmitting, in response to a triggering event, a control message to a haptic device of the electronic device, the control message configured to cause the haptic device to generate haptic feedback in accordance with the adjusted haptic feedback intensity.

11. The method of claim 10, wherein said sensor is selected from the group consisting of a device motion sensor, a biosensor, or a combination thereof.

12. The method of claim 11, wherein said sensor comprises a device motion sensor selected from the group consisting of an accelerometer, a global positioning system, a gyroscope, or one or more combinations thereof.

13. The method of claim 10, wherein determining said adjusted haptic feedback intensity is performed at least in part by comparing contextual information in said contextual information signal to one or more thresholds.

14. The method of claim 13, wherein:
said contextual information comprises accelerometer data, said one or more thresholds comprise a plurality of accelerometer thresholds, each of which is associated with a corresponding adjusted haptic feedback intensity; and
determining said adjusted haptic feedback intensity comprises comparing said accelerometer data to said plurality of thresholds.

15. The method of claim 13, wherein:
said contextual information comprises gyroscope data;
said electronic device further comprises a database correlating a plurality of device orientations to a corresponding adjusted haptic feedback intensity; and
determining said adjusted haptic feedback intensity comprises determining an orientation of said electronic device based at least in part on said gyroscope data, and comparing said orientation to said database.

16. The method of claim 13, wherein:
said contextual information comprises accelerometer data and gyroscope data; and
determining said adjusted haptic feedback intensity is based at least in part on a combination of said accelerometer data and said gyroscope data.

17. The method of claim 13, wherein:
said contextual information comprises accelerometer data and gyroscope data;
determining said adjusted haptic feedback intensity comprises:
determining an initial adjusted haptic feedback intensity based on one of said accelerometer data and said gyroscope data; and
tuning said initial adjusted haptic feedback intensity based on the other of said accelerometer data and said gyroscope data.

18. At least one computer readable medium comprising instructions which when executed by a processor of an electronic device cause the electronic device to perform the following operations comprising:
determining an adjusted haptic feedback intensity based at least in part on contextual information detected or otherwise provided by a contextual information sensor; and
transmitting, in response to a triggering event, a control message to a haptic device of the electronic device, the control message configured to cause the haptic device to generate haptic feedback in accordance with the adjusted haptic feedback intensity.

19. The at least one computer readable medium of claim 18, wherein said sensor is selected from the group consisting of a device motion sensor, a biosensor, or a combination thereof.

20. The at least one computer readable medium of claim 19, wherein said sensor comprises a device motion sensor selected from the group consisting of an accelerometer, a global positioning system, a gyroscope, or one or more combinations thereof.

21. The at least one computer readable medium of claim 18, wherein determining said adjusted haptic feedback intensity is performed at least in part by comparing contextual information in said contextual information signal to one or more thresholds.

22. The at least one computer readable medium of claim 21, wherein:
said contextual information comprises accelerometer data, said one or more thresholds comprise a plurality of accelerometer thresholds, each of which is associated with a corresponding adjusted haptic feedback intensity; and
determining said adjusted haptic feedback intensity comprises comparing said accelerometer data to said plurality of thresholds.

23. The at least one computer readable medium of claim 21, wherein:
said contextual information comprises gyroscope data;
said electronic device further comprises a database correlating a plurality of device orientations to a corresponding adjusted haptic feedback intensity; and
determining said adjusted haptic feedback intensity comprises determining an orientation of said electronic device based at least in part on said gyroscope data, and comparing said orientation to said database.

24. The at least one computer readable medium of claim 21, wherein:
said contextual information comprises accelerometer data and gyroscope data; and
determining said adjusted haptic feedback intensity is based at least in part on a combination of said accelerometer data and said gyroscope data.

25. The at least one computer readable medium of claim 21, wherein:
said contextual information comprises accelerometer data and gyroscope data;
determining said adjusted haptic feedback intensity comprises:
determining an initial adjusted haptic feedback intensity based on one of said accelerometer data and said gyroscope data; and
tuning said initial adjusted haptic feedback intensity based on the other of said accelerometer data and said gyroscope data.
